(19) United States
(12) Patent Application Publication
(10) Pub. No.: US 2012/0016686 A1
(43) Pub. Date: Jan. 19, 2012

(54) INPATIENT BLOOD MANAGEMENT

(75) Inventors: HUGH RYAN, LEE'S SUMMIT, MO (US); JASON HOWARD, LEE'S SUMMIT, MO (US); BHARAT SUTARIYA, PARKVILLE, MO (US)

(73) Assignee: CERNER INNOVATION, INC., OVERLAND PARK, KS (US)

(21) Appl. No.: 12/835,433

(22) Filed: Jul. 13, 2010

(51) Int. Cl. G06Q 50/00

(52) U.S. Cl. 705/2

(57) ABSTRACT

Methods, systems, and computer storage media are provided for enabling management of a patient's blood when the patient has been admitted to a healthcare facility but does not have a scheduled procedure. A patient who is admitted to the healthcare facility is identified and based on the patient's red blood cell measurements, it is determined that the patient is anemic. It is determined that the patient requires blood treatment based on these red blood cell measurements. Blood treatment instructions are determined by way of algorithms, and these instructions are displayed in the patient's electronic medical record such that a clinician can determine, based on the recommended instructions, which interventions to administer to the patient.

### CROSS REFERENCE TO RELATED APPLICATIONS

This application is related to commonly assigned U.S. Patent Application entitled “BLOOD MANAGEMENT FOR OUTPATIENT PROCEDURES” (Attorney Docket CRNI.154685) filed concurrently herewith on the same date.

### BACKGROUND

Blood transfusions, although associated with many risks, have become routine when a patient's blood levels are low as a result of a surgical procedure having a high risk of blood loss. These risks include disease transmission, transfusion reactions, negative outcomes, storage issues, decreased availability of blood donors, refusal of blood transfusions for religious reasons, and high cost. Some of the negative outcomes include a prolonged postoperative ventilator support, a longer hospital stay, increased postoperative morbitiy/mortality, earlier cancer recurrence, diminished organ function, delayed wound healing, and complications including pneumonia and other infections. The minimum cost for a blood transfusion has been reported to be $1400 per incident.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to blood management techniques that minimize or even eliminate the need for a blood transfusion as a result of a surgical procedure that is associated with a high risk of blood loss. Exemplary procedures are listed herein, and may include vascular, orthopedic, cardiac, cancer-related, gynecological, and other invasive procedure. In embodiments, the procedure is an elective procedure. Not only would those patients scheduled for a high-risk procedure benefit from blood management prior to the procedure, but patients who have been diagnosed with anemia and who may currently be admitted to a healthcare facility would also benefit from blood management. As used herein, blood management includes various interventions that improve patient outcomes, and which are achieved with the reduction or avoidance of exposure to allogeneic blood, or blood coming from a person other than the recipient. These interventions may include, for example, erythropoietin, intravenous (IV) or oral iron, folate, vitamin B12, and vitamin C.

Accordingly, in one aspect, the present invention is directed to one or more computer storage media storing computer-useable instructions that, when used by one or more computing devices, cause the one or more computing devices to perform a method. The method includes identifying a patient who is currently admitted to a healthcare facility and determining that the patient is anemic such that one or more red blood cell measurements associated with the patient are below a predetermined threshold. Further, the method includes determining that the patient requires blood treatment based on the one or more red blood cell measurements, algorithmically determining blood treatment instructions for the patient, and displaying the blood treatment instructions.

In another aspect, the present invention is directed to one or more computer storage media storing computer-useable instructions that, when used by one or more computing devices, cause the one or more computing devices to perform a method. The method includes receiving a first set of blood test results that includes a hemoglobin count for a patient who has been admitted to a healthcare facility. The patient is not scheduled for a procedure that is associated with a high risk of blood loss. The method additionally includes automatically populating an electronic medical record associated with the patient with the first set of blood test results and determining that the hemoglobin count does not meet a predetermined lower threshold indicating that the patient is anemic. Further, the method includes ordering a second set of blood tests to determine a recommended blood treatment, receiving a second set of blood test results, and determining the recommended blood treatment based on the first set of blood test results and the second set of blood test results. The method also includes communicating for display on the electronic medical record blood treatment instructions.

In yet another aspect, the present invention is directed to one or more computer storage media storing computer-useable instructions that, when used by one or more computing devices, cause the one or more computing devices to perform a method. The method includes receiving blood test results associated with a patient who has been admitted to a healthcare facility, and automatically populating an electronic medical record associated with the patient with the blood test results. The blood tests results indicate levels of one or more of a hemoglobin concentration, hematocrit, or a red blood cell count. Further, the method includes, based on the blood test results, determining that the patient is eligible for blood treatment such that the blood test results indicate that the patient is anemic. The method additionally includes algorithmically determining customized blood treatment instructions that are based on the blood test results for the patient and communicating for presentation the customized blood treatment instructions.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is an exemplary system architecture suitable to implement embodiments of the present invention;

FIGS. 3-4 are flow diagrams showing methods for outpatient blood management, in accordance with embodiments of the present invention;

FIG. 5 is a flow diagram of a use-case scenario for an exemplary outpatient procedure, in accordance with an embodiment of the present invention;

FIGS. 6-8 are screenshots of graphical user interfaces for outpatient blood management, in accordance with embodiments of the present invention;

FIGS. 9-11 are flow diagrams showing methods for inpatient blood management, in accordance with embodiments of the present invention;

FIGS. 12-14 are flow diagrams used to determine blood treatment instructions for inpatient blood management, in accordance with embodiments of the present invention; and

FIGS. 15-16 are screenshots of graphical user interfaces for inpatient blood management, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide computerized methods and systems for providing blood treatment instructions for a patient who is scheduled for an elective procedure that is associated with a high-risk of blood loss. Embodiments of the present invention further provide computerized methods and systems for providing blood treatment instructions for a patient who has been admitted to a healthcare facility, but who is not currently scheduled for a procedure associated with a high-risk of blood loss. Still further, embodiments of the present invention provide graphical user interfaces for displaying data related to a patient's blood management, including patient-identifying information, blood tests that have been performed or scheduled, blood test results, recommended interventions, etc. An exemplary operating environment is described below.

As mentioned, blood transfusions are very costly and are associated with many risks, thus making other less risky and less expensive options more attractive. Even before a blood transfusion may be necessary or before a patient is scheduled for a surgical procedure having a high risk of blood loss, many individuals are diagnosed with anemia, which is a reduction in one or more of the major red blood cell measurements, such as hemoglobin concentration, hematocrit, or red blood cell (RBC) count. These individuals are at a higher risk for a blood transfusion and other blood-related complications should they ever require a surgical procedure associated with a high risk of blood loss.

Other embodiments of the present invention provide for algorithms that are used to determine blood treatment instructions for a particular patient. These instructions are determined based on patient-specific information and blood test results for the patient, and may vary depending on the circumstances surrounding the reason for the patient receiving blood treatment. For instance, a patient may receive blood treatment (e.g., interventions) because of a high-risk elective procedure that has been scheduled for the patient. In this instance, the blood treatment that the patient receives, including dosages, may depend on how many days in advance of the procedure the blood treatment is started. The optimal scenario is when the elective procedure is scheduled at least thirty days in advance such that there is plenty of time for the blood treatment. Even if a procedure is not scheduled, a patient may be diagnosed with anemia, and would benefit from some form of blood treatment. Therefore, the type of blood treatment and recommended dosages may also depend on how much time is available for the blood treatment.

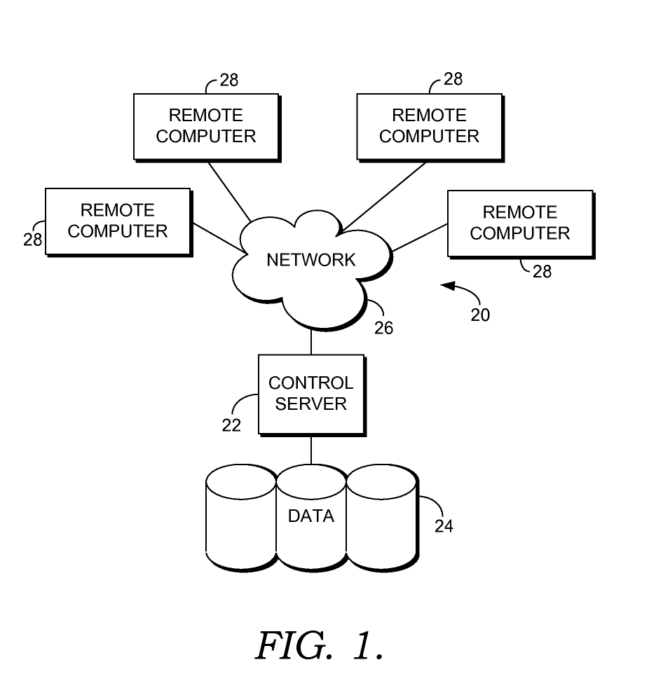

Having briefly described embodiments of the present invention, an exemplary operating environment suitable for use in implementing embodiments of the present invention is described below. Referring to the drawings in general, and initially to FIG. 1 in particular, an exemplary computing system environment, for instance, a medical information computing system, on which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a server 22. Components of the server 22 may include, without limitation, a processing unit, internal system memory, and a suitable system bus for coupling various system components, including database cluster 24, with the server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 22 typically includes, or has access to, a variety of computer-readable media, for instance, database cluster 24. Computer-readable media can be any available media that may be accessed by server 22, and includes volatile and nonvolatile media, as well as removable and non-removable media. By way of example, and not limitation, computer-readable media may include computer storage media and communication media. Computer storage media may include, without limitation, volatile and nonvolatile media, as well as removable and nonremovable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 24, provide storage of computer-readable instructions, data structures, program modules, and other data for the server 22.

The server 22 may operate in a computer network 26 using logical connections to one or more remote computers 28. Remote computers 28 may be located at a variety of locations in a medical or research environment, for example, but not limited to, clinical laboratories, hospitals and other inpatient settings, veterinary environments, ambulatory settings, medical billing and financial offices, hospital administration settings, home healthcare environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 28 may also be physically located in nontraditional medical care environments so that the entire healthcare community may be capable of integration on the network. The remote computers 28 may be personal computers, servers, routers, network PCs, peer devices, other common network nodes, or the like, and may include some or all of the components described above in relation to the server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., server 22 and remote computers 28) may be utilized.

In operation, a user may enter commands and information into the server 22 or convey the commands and information to the server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 22. In addition to a monitor, the server 22 and/or remote computers 28 may include other peripheral output devices, such as speakers and a printer.

Although many other internal components of the server 22 and the remote computers 28 are not shown, those of ordinary skill in the art will appreciate that such components and their interconnection are well known. Accordingly, additional details concerning the internal construction of the server 22 and the remote computers 28 are not further disclosed herein.

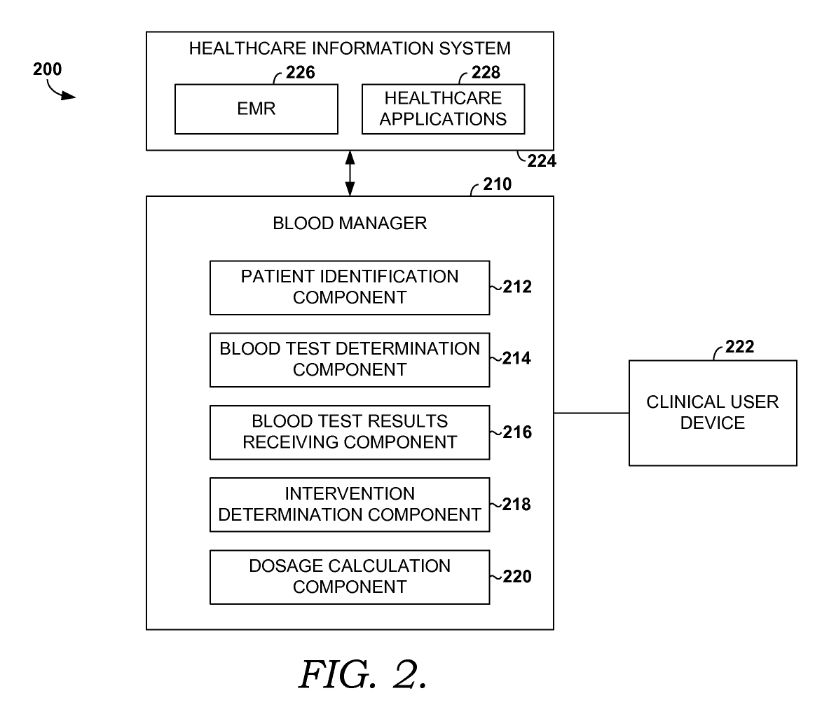

Turning now to FIG. 2, an exemplary system architecture is shown and identified generally by reference numeral 200. The system 200 includes a blood manager 210, one or more clinical user devices, illustrated as clinical user device 222, and a healthcare information system 224. Other components not shown here may also be used to carry out aspects of the present invention. These components not shown may include, for example, a database that stores blood test results before the results are sent to the patient's electronic medical record (EMR), and a network that is used to communicate data from each component shown in FIG. 2. Further, several components shown in FIG. 2 may be combined into a single component although shown separately in FIG. 2. Alternatively, components, such as the clinical user device 222, although shown as a single component, may actually be two or more devices.

The blood manager 210 includes a patient identification component 212, a blood test determination component 214, a blood test results receiving component 216, an intervention determination component 218, and a dosage calculation component 220. Each component of the blood manager 210 assists in managing blood for one or both of inpatient or outpatient scenarios. There are many procedures and other surgeries that are classified as having a high risk of blood loss, and may include procedures in the categories of vascular, orthopedic, cardiac, cancer-related, and gynecological. These procedures may require one or more blood transfusions. More specifically, these procedures may include valve replacement, redo bypass grafting, aortic arch aneurysm, coronary artery bypass, valve/CABG combo, pneumonectomy/lobectomy, spinal fusion, bilateral knee replacement, knee replacement, hip replacement, radical retropubic prostatectomy, cystectomy, nephrectomy, giant basilar aneurysm, cerebral aneurysm, myomectomy, breast reduction/reconstruction, abdominal hysterectomy with enlarged uterus, thoracoabdominal aortic aneurysm repair, aorto-bifemoral grafts, axillo-femoral bypass, abdominal aortic aneurysm repair, liver resection, whipple procedure, splenectomy, and thoracic aortic aneurysm repair. Of course, other procedures not listed here may also have a high risk of blood loss, and this list is not exhaustive.

While some of the procedures listed above can be scheduled in advance, others may be emergent procedures and there may not be much time between the scheduling of the procedure and the procedure itself. In one embodiment, outpatient blood management involves some type of procedure that is scheduled for a predetermined quantity of days in advance of the procedure itself, thus allowing enough time for proper blood treatment. For instance, a hip replacement procedure may be scheduled at least 21 days, or in some cases, even more than 30 days in advance of the procedure itself. In another embodiment, a procedure cannot be scheduled this far in advance, including many cardiac procedures. The patients scheduled for these urgent or emergent procedures may still benefit from some type of blood treatment. Alternatively, a procedure may not be scheduled at all, but the patient may have been admitted to a healthcare facility for some reason. In these instances, inpatient blood management may be used to treat the patient. As mentioned, a procedure may not be scheduled, and may never be scheduled, but an anemic patient who has already been admitted to a healthcare facility may benefit from blood treatment. To decrease the need for blood transfusions and associated adverse side effects, the blood manager 210 enables the identification of anemic patients, as these are the patients who would benefit the most from blood treatment, and automatically determines recommended blood treatment instructions for that patient. In effect, this reduces or even removes the need of a clinician, such as a nurse, doctor, blood specialist, or other healthcare personnel from the process of generating blood treatment instructions.

Generally, the patient identification component 212 identifies those patients who are anemic and who may benefit from blood treatment. Anemia is the reduction in one or more of the major red blood cell (RBC) measurements, including hemoglobin concentration, hematocrit, or RBC count. Hemoglobin concentration (HGB) measures the concentration of the major oxygen-carrying pigment in whole blood. Values may be expressed as grams of hemoglobin per 100 mL of whole blood (g/dL) or per liter of blood (g/L). Hematocrit (HCT) is the percent of a sample of whole blood occupied by intact red blood cells. Finally, RBC count is the number of red blood cells contained in a specified volume of whole blood, usually expressed as millions of red blood cells per microL of whole blood. Key strategies in managing blood include maintaining euvolemia, or the presence of the proper amount of blood in the body, minimizing latrogenic blood loss, preoperative priming, blood conservation techniques, and tolerance or treatment of anemia. Patients may be identified as having anemia based on blood test results received within a predetermined number of days, such as 45 days. After 45 days, blood test results may no longer be accurate, and the patient may be asked to have more blood tests performed. In one embodiment, blood test results are automatically populated into a patient's EMR, which will be discussed in further detail. In another embodiment, the results are manually entered into the EMR. Further, in one embodiment, the patient identification component 212 causes an alert for a healthcare provider that indicates that the patient may be considered anemic to assist the healthcare providers in identifying anemic patients.

The blood test determination component 214 determines whether the patient needs initial or additional blood tests. As will be explained in greater detail below, additional blood tests may be needed to fully assess a patient's need for a certain blood treatment. For instance, depending on a hemoglobin concentration in the patient's blood, patients may be further tested for one or more of vitamin B12 level, reticulocyte count, RHC, iron, iron binding capacity (IBC), femitin, TSAT, creatinine, etc.

The blood test results receiving component 216 receives blood test results. In one embodiment, the blood test results receiving component 216 is responsible for automatically populating the patient's EMR with the blood test results. The results may be received from a device from another healthcare facility, or may be received from the same healthcare facility that is responsible for the patient's care. Alternatively, the test results may be manually entered and received by the blood test results receiving component 216. This may occur, for instance, if the healthcare entity performing the blood tests uses software different than the entity responsible for the care of the patient.

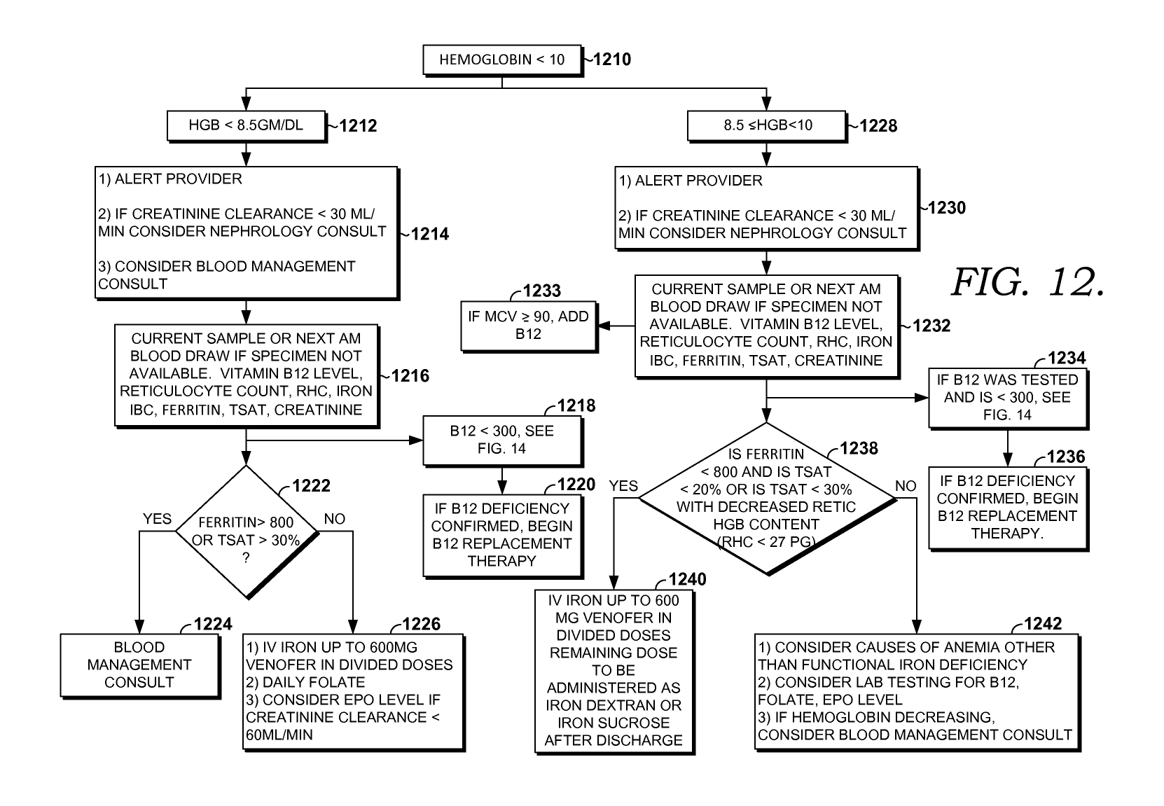

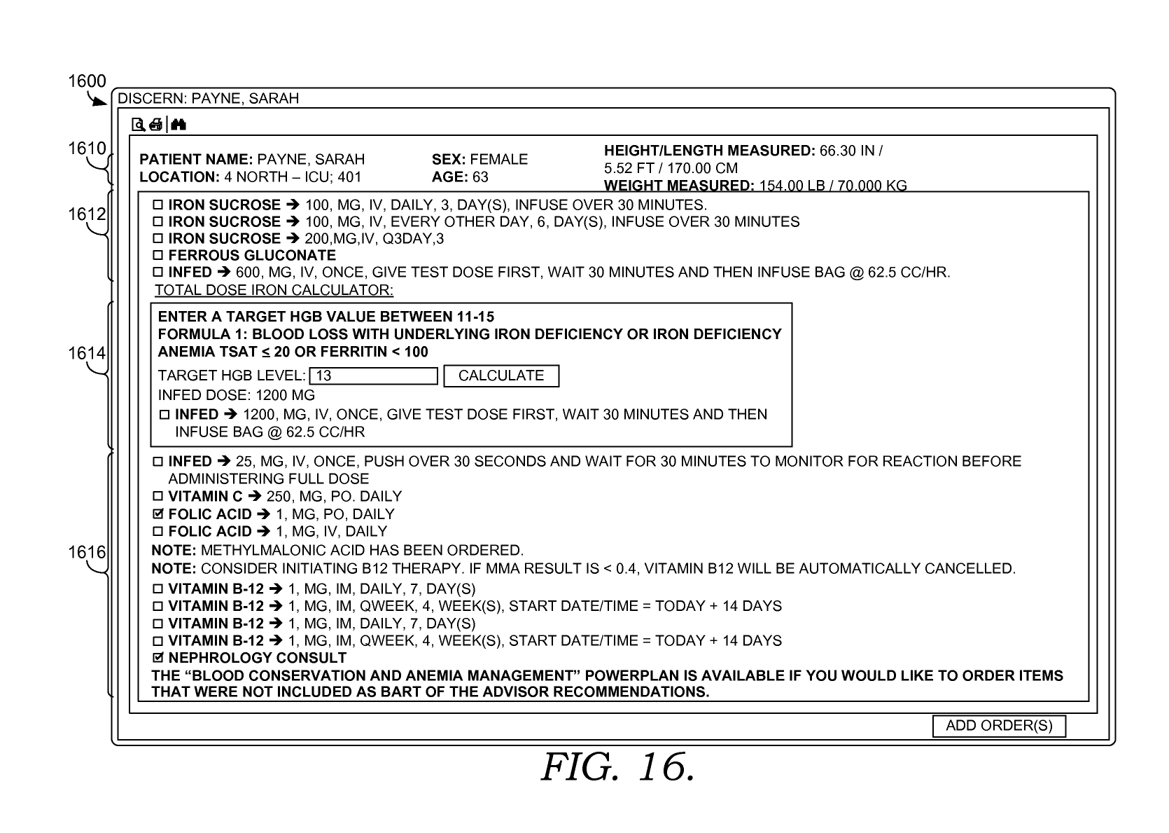

The intervention determination component 218 is responsible for determining which types of blood treatment are appropriate for the patient based on the patient's blood test results. The intervention determination component 218 includes algorithms, such as those described in relation to FIGS. 12-14, to determine which interventions to recommend. These algorithms will be discussed further. Once the types of interventions or blood treatments are determined, the dosage calculation component 220 calculates a dosage for each of the treatment options that require a dosage. This dosage may then be recommended to the healthcare provider. For instance, an iron dosage may be determined based on both the patient's current hemoglobin concentration and the patient's target hemoglobin concentration. This will be discussed further in relation to FIG. 16. The dosage may be displayed on a display device so that the healthcare provider can review the recommended dosages and make any changes necessary prior to beginning the blood treatment.

An exemplary dosing formula will be detailed for iron dextran (InFeD) blood treatment. The formula is used for blood loss with underlying iron deficiency or iron deficiency anemia where TSAT is less than or equal to 20% or ferritin is less than 100. The dosage of InFeD in milligrams (mg) is equal to: 2.4×LBW(13−observed hemoglobin)+500. LBW, or lean body weight is equal to 45.5 kg+2.3 kg for each inch of the patient's height over 5 feet. Further, each mL of InFeD contains the equivalent of 50 mg of elemental iron. The desired hemoglobin concentration of 13 g/dL is used for the majority of patients. If the target hemoglobin concentration is higher, it can be changed in the calculation. A second formula is provided and used for blood loss without underlying iron deficiency, such as if TSAT is between 20% and 35%. The dosage, in mg, is 2.4×LBW(13−observed high).

The clinical user device 222 includes one or more devices that are used within a healthcare facility to receive, display and send information to a user, such as a clinician. The clinical user device 222 also facilitates requests to receive additional information. Exemplary clinical user devices 222 include personal communication devices, a clinician computer workstation, and an email system. Personal communication devices include devices that are used by an individual to receive and send information, such as an in-house phone, a pager, and a mobile device. Workstations include a remote computer terminal that is used to present information to a user, such as a clinician, and receive input. Workstations might be set up at a nurse's station or at a patient bedside. Accordingly, in an embodiment of the present invention, the clinical user device 222 presents to users information that is received from other components of operating environment 200. Moreover, the clinical user device 222 might also receive inputs from a clinician that are communicated to other components of operating environment 200. The clinical user device 222 also communicates to other components of operating environment 200 requests to receive additional information. For example, the clinical user device 222 might communicate information to various components within the blood manager 210 such that the information is later communicated to the patient's EMR.

Healthcare information system 224 includes an integrated system of healthcare-related information that is usable by a healthcare facility to operate and provide patient care. For example, healthcare information system 224 includes an electronic medical record 226 (also referred to herein as “EMR”) and a healthcare applications component 228. EMR 226 includes an electronic version of patient records including information for the patient, such as medication and infusion orders, tasks, images, examination reports, testing and lab results, medical history, etc. Healthcare applications component 228 includes information that is input and provided at a patient's point-of-care (e.g., patient bedside) to assist healthcare professionals to provide appropriate care. An exemplary healthcare applications component 228 includes a patient order entry component for entering electronic healthcare orders for a patient. In an embodiment of the present invention, healthcare information system 224 receives information from other components, as will be described in more detail below. Moreover, healthcare information system 224 might also provide information that is communicated to other components of operating environment 200.

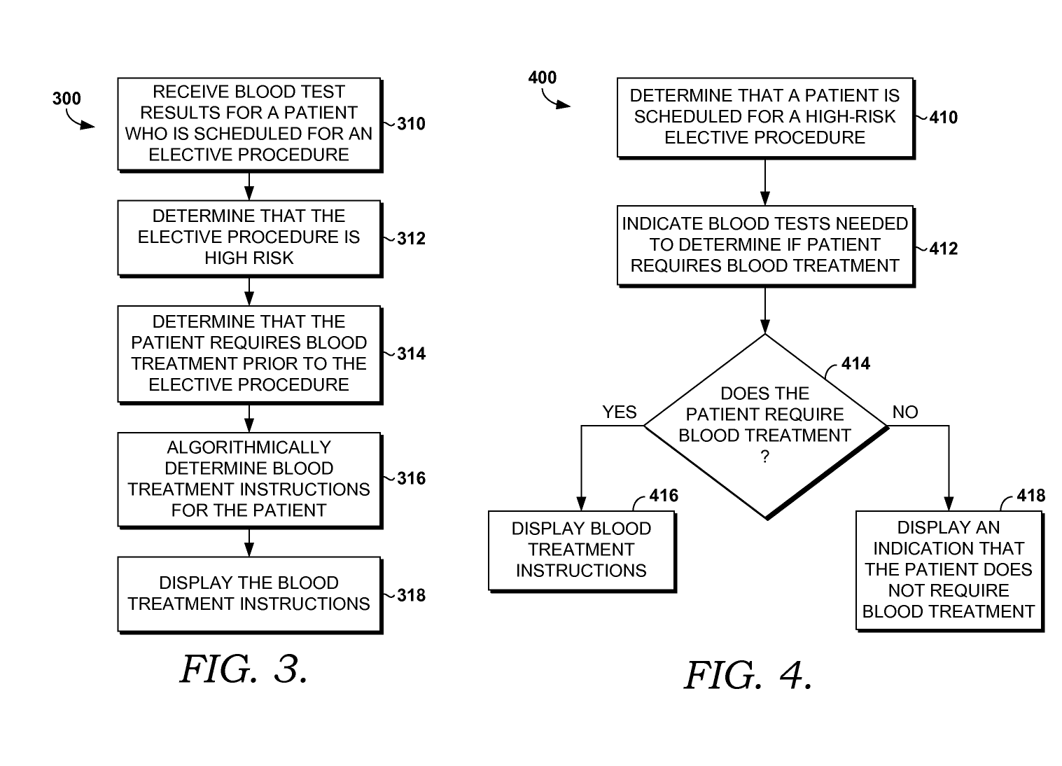

FIG. 3 is a flow diagram showing a method 300 for outpatient blood management, in accordance with an embodiment of the present invention. As mentioned, outpatient blood management is the blood management of a patient who has a scheduled procedure, such as an elective procedure, but who is not admitted to a healthcare facility in relation to that elective procedure. Typically, the procedure is scheduled far enough in advance so that blood treatment has time to be effective. This may be a predetermined number of days in advance of the procedure, such as 21 or 30 days in advance. Some forms of blood treatment provide maximum results when given several days apart, and as such, the more time a patient has before the scheduled procedure, the more effective these forms of blood treatment may be. Also as mentioned, the procedures referred to herein in relation to outpatient blood management are those listed above and any others that are associated with a high risk of blood loss. Patients undergoing these types of procedures have a high probability of requiring a blood transfusion as a result of the procedure. As used herein, a high risk of requiring a blood transfusion is generally greater than a 10% chance. The blood treatment referred to herein does not include blood transfusions but, to the contrary, reduces or avoids the need of exposure to allogeneic blood, which is blood that comes from a different individual than the recipient. As used herein, blood management generally refers to the appropriate provision and use of blood, its components and derivatives, and strategies to reduce or avoid the need for a blood transfusion. Therefore, blood treatment may include various interventions including, for exemplary purposes only, erythropoietin, intravenous or oral iron supplementation, folate, vitamin B12, or vitamin C. These interventions may be administered in combination or individually.

Initially, as shown at step 310, blood test results are received for a patient who is scheduled for an elective procedure. Blood tests performed on the patient's blood may initially include one or more of a hemoglobin concentration, hematocrit (HCT), or a red blood cell (RBC) count. In one embodiment, an initial blood test measures the hemoglobin concentration in the patient's blood, and depending on the result, other blood tests, such as those listed above, are performed. In other embodiments, depending on the results of one or more of the blood tests listed above, further blood tests may be ordered to determine levels or concentration of, for instance, iron, vitamin B12, vitamin C, reticulocyte, RHC, ferritin, TSAT, creatinine, etc. in the patient's blood. The blood test results, once received, are recorded in an electronic medical record (EMR) that is associated with the patient. In one embodiment, the results are automatically populated in the EMR, but in another embodiment, the results are manually entered into the EMR. At step 312, it is determined that the elective procedure is high risk. A high-risk procedure is one that may be associated with blood loss that may typically require a blood transfusion. High-risk procedures have a greater risk of blood loss than lower-risk elective procedures that may not be intrusive.

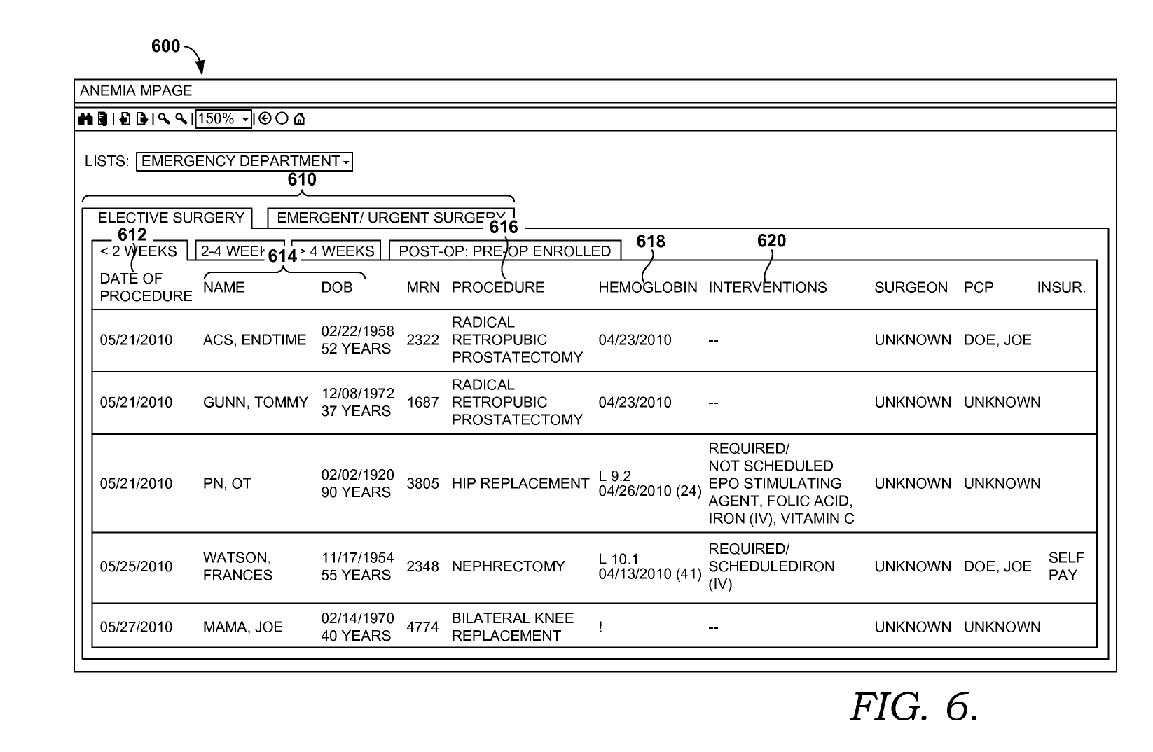

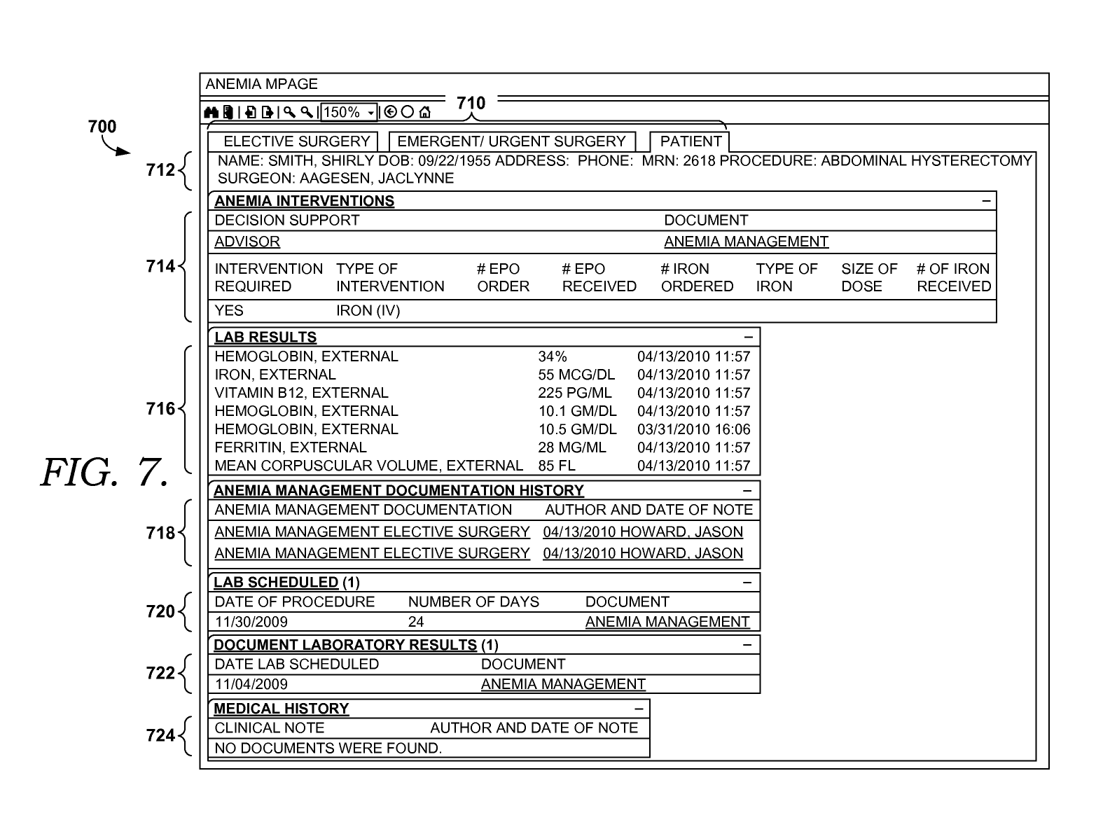

At step 314, it is determined that the patient requires blood treatment prior to the elective procedure. This determination is based on the blood test results. In one embodiment, a patient with a hemoglobin concentration below 12 gm/dL is eligible for, or may require some form of blood treatment. The exact concentration of hemoglobin indicating anemia may vary depending on the gender, health status, age, etc., of the patient. Once it is determined that blood treatment is required, blood treatment instructions are algorithmically determined for the patient at step 316. For instance, in one embodiment, a patient with a hemoglobin concentration below 8.5 gm/dL and a vitamin B12 level below 300 may have a B12 deficiency and may need B12 replacement therapy. Alternatively, a patient with a hemoglobin concentration below 8.5 gm/dL but whose ferritin level is below 800 and whose TSAT is less than 30% may require at least IV iron and daily folate. Exemplary blood treatment interventions include vitamin B12 replacement therapy, iron therapy, erythropoietin stimulating agent supplementation, folate supplementation, vitamin C supplementation, or a blood management consultation. At step 318, the blood treatment instructions are displayed, as further illustrated and described in relation to FIGS. 6-7.

Referring to FIG. 4, a flow diagram is illustrated of a method 400 for outpatient blood management, in accordance with an embodiment of the present invention. It is determined that a patient is scheduled for a high-risk elective procedure at step 410 such that a substantial risk of blood loss is associated with the procedure. In embodiments, a database of EMRs may be inspected to identify a plurality of patients that meet criteria for receiving blood treatment. These patients may each have a scheduled high-risk elective procedure and may be considered anemic. At step 412, blood tests are indicated that are needed to determine if the patient requires some form of blood treatment prior to the procedure. In one embodiment, blood tests may have been previously performed, and depending on how long ago they were performed, those results may be used. For instance, blood tests performed within the last 45 days may still be valid in determining whether the patient requires blood treatment. If the blood tests in the EMR were performed prior to 45 or another predetermined number of days ago, an indication is provided that certain blood tests need to be scheduled and performed. The procedure, in embodiments, is scheduled far enough in advance such that the blood treatment is effective. In some cases, this may be 21 days in advance, or 30 or more days in advance. The blood tests may measure, for instance, hemoglobin, ferritin, transferring saturation, vitamin B12, reticulocyte, reticulocyte hemoglobin, iron, or mean corpuscular volume (MCV).

Based on the blood test results corresponding to the blood tests in the patient's EMR, it is determined whether the patient requires blood treatment, shown at step 414. If the patient does require blood treatment, the blood treatment instructions are displayed, illustrated at step 416. Blood treatment instructions may include not only a specific form of intervention, but if applicable, a dosage associated with the intervention. For instance, if iron therapy is recommended, a dosage of iron is calculated and displayed. Dosages may be calculated based on a weight of the patient (e.g., lean body weight), a target hemoglobin concentration, etc. If it is determined that the patient does not require blood treatment, an indication is displayed on a display device, such as in the patient's EMR, that the patient does not require blood treatment, shown at step 418. In one embodiment, one or more of the blood tests are repeated just prior to the scheduled procedure to determine whether any of the blood test results have varied. This ensures that the patient is ready for the procedure such that the patient may no longer be considered anemic, or at least that blood test results have improved.

In a further embodiment, upon completion of the blood treatment, one or more pretreatment test results may be received. Based on these results, it may be determined whether it is safe for the patient to undergo the scheduled high-risk elective procedure. In either case, an indication may be displayed whether or not it is safe for the patient to undergo the procedure at the current time. For instance, if it is determined that the patient's blood test results have not improved enough such that it would be safe to undergo the procedure, an indication is displayed that it is not safe. Alternatively, if the patient's blood test results have significantly improved such that it is safe to undergo the procedure that may otherwise require a blood transfusion, an indication is displayed that it is safe to undergo the procedure at the current time.

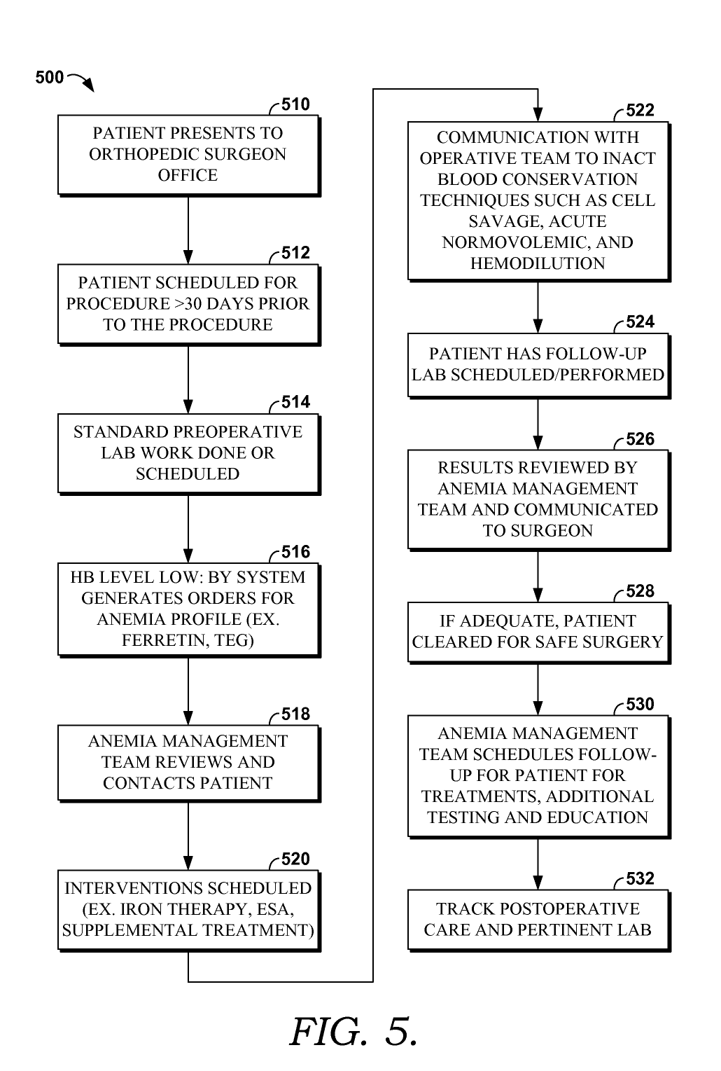

Turning now to FIG. 5, a flow diagram is shown of a use-case scenario 500 for an exemplary outpatient procedure, in accordance with an embodiment of the present invention. In the embodiment of FIG. 5, the outpatient procedure is a hip replacement, which is a procedure that can be scheduled well in advance. The prevalence of anemia in patients receiving hip replacements has been reported anywhere from 10 to 45%, and therefore patients undergoing hip replacement therapy stand to greatly benefit from blood management. Initially at step 510, the patient meets with an orthopedic surgeon at the surgeon's office. At step 512, the patient is scheduled for the hip replacement procedure for 30 or more days in advance of the procedure. The standard preoperative lab work is performed or scheduled at step 514. At step 516, it is determined that the hemoglobin concentration or level is low. The system generates orders for an anemia profile, which includes blood tests that test ferretin, TEG, and others. An anemia management team reviews and contacts the patient at step 518. At step 520, interventions are scheduled. As mentioned, interventions may include, for example, iron therapy, ESA, supplemental treatment (e.g., vitamin B12, vitamin C), or the like. Continuing to step 522, other blood conservation techniques are considered, such as cell savage, acute normovolemic, and hemodilution. At step 524, the patient has a follow-up lab scheduled and performed. The results of the lab tests are reviewed by the anemia management team and are communicated to the surgeon at step 526. If the results are adequate, the patient is cleared for safe surgery, shown at step 528. The anemia management team schedules a follow-up for the patient for additional treatments, additional testing, and education in relation to the hip replacement procedure. This is shown at step 530. Finally, at step 532, postoperative care and pertinent labs are monitored.

FIG. 6 is a screenshot of a graphical user interface 600 for outpatient blood management, in accordance with embodiments of the present invention. Display area 610 illustrates an elective surgery tab and an emergent/urgent surgery tab. Here, the elective surgery tab is selected. Under the elective surgery tab are various other tabs that can also be selected. Each of these tabs displays pertinent information for different periods of time prior and subsequent to the procedure. For instance, FIG. 6 shows the “<2 weeks” tab as being selected. The information shown is for multiple patients who have elective surgeries scheduled. The categories of information are listed in various display areas, including a procedure date display area 612, a patient-identifying display area 614, a procedure name display area 616, a blood test scheduling and results display area 618, and an intervention display area 620. Other display areas are shown in FIG. 6, including a display area for a medical record number (MRN) or other identifier, the name of the surgeon, if known, the primary care physician (PCP), and the type of insurance.

The procedure date display area 612 lists the scheduled date on which the patient is to have the procedure. The patient-identifying display area 614 may include, for example, the patient's name, the patient's date of birth, the patient's age, an identification number, or the like. In one embodiment, the name of the patient may be linked to a patient-specific page that includes further information in relation to that patient. The link allows a caregiver to simply click or otherwise select the patient's name to view more detailed patient-specific information. Additionally, the patient's name in this column may be color coded indicating that the patient is scheduled for more than one procedure in a certain period of time (e.g., within 60 days, within 90 days), that the patient is refusing a blood transfusion such that “bloodless medicine,” including interventions described herein will be used to treat the patient prior to the scheduled procedure, or the like.

The procedure name display area 616 names the procedure, including, for example, a radical retropubic prostatectomy, a hip replacement, nephrectomy, bilateral knee replacement, etc. There are many procedures that may be performed on a patient, and the list of examples provided herein is not exhaustive. The blood test scheduling and results display area 618 may display any type of blood test results. Here, hemoglobin concentration results are displayed. In one instance, as indicated by the “!” in the blood test scheduling and results display area 618, in the case of a hemoglobin blood test, a hemoglobin test result has not been found and a lab for a hemoglobin blood test has not yet been scheduled. The “!” may indicate to a clinician or other healthcare worker that a lab should be scheduled. In another instance, a date is shown in this column. If the date indicated has passed, this may indicate that the blood work was scheduled but no blood test results have been found, such as if the patient was not present for the scheduled lab work. Alternatively, if the date displayed has not passed, this may indicate the date of the scheduled blood test. In yet another instance, the blood test scheduling and results display area 618 may display both a blood test result and a date, indicating that the blood work has been performed on the date shown. Here, a number in parenthesis may be displayed to indicate how many days between the date the blood tests were performed and the date of the procedure. As shown for patient “Watson, Frances,” there are 41 days between the date of the blood test (Apr. 13, 2010) and the scheduled date of the procedure (May 25, 2010). In one embodiment, the blood test result may be color coded to indicate either that the result is low for that particular patient, that the result is high, or that the result is normal. For instance, a hemoglobin test result that is blue in color may indicate that the result is low for that particular patient and that interventions are recommended.

Continuing with reference to FIG. 6, the intervention display area 620 indicates whether an intervention has been determined and/or scheduled for the particular patient. Some patients may not require an intervention or may not have had blood tests performed, and in these cases the intervention display area 620 for those particular patients may not display a recommended intervention. Other patients who have had blood tests performed may have scheduled interventions. For instance, the patient identified as “Watson, Frances” has a required intervention that has been scheduled. The intervention is iron replacement therapy in the intravenous (IV) form. Another patient identified as “PN, OT” has a required intervention indicated that has not yet been scheduled. The intervention is EPO stimulating agent, folic acid, iron (IV), and vitamin C. Portions of the displayed text in the intervention display area 620 may also be color coded. For instance, if the intervention has not yet been scheduled, a link or a colored link may be displayed allowing the clinician or other caregiver to click on or otherwise select the link to schedule the intervention.

Turning to FIG. 7, a screenshot is shown of a graphical user interface 700 for outpatient blood management, in accordance with embodiments of the present invention. Various tabs are shown and are illustrated by item 710. These tabs include elective surgery, emergent/urgent surgery, and a patient tab. Exemplary data is shown in FIG. 7 that is related to a particular patient identified as “Smith, Shirly.” Various display areas are shown, including a patient-identifying display area 712, an anemia interventions display area 714, a lab results display area 716, an anemia management documentation history display area 718, a lab scheduled display area 720, a document laboratory results display area 722, and a medical history display area 724.

The patient-identifying display area 712 displays information such as the patient's name, date of birth, address, phone number, MRN or other identifier, procedure name, surgeon, etc. The anemia interventions display area 714 displays data pertaining to any interventions that are scheduled or recommended for the patient as a result of the patient's blood test results. For example, this information may include whether an intervention is required, the type of intervention, the amount of EPO ordered, the amount of EPO received, the amount of iron ordered, the type of iron, the size of the dose, and the amount of iron received. The lab results display area 716 displays blood tests that have been performed, the results of the blood tests, and the date and time that the test was performed. Other data related to the blood tests not shown here may also be included, and is contemplated to be within the scope of the present invention. The anemia management documentation history display area 718 includes links to the program coordinator's documentation. The lab scheduled display area 720 illustrates the date of a scheduled procedure, a number of days until the scheduled procedure [inventors to confirm], and a link to any reference documents, if necessary. A number “1” in parenthesis indicates that one lab is scheduled and listed below. The document laboratory results display area 722 also has a “1” in parentheses, indicating that one document is listed below. The date of the scheduled blood test and a link to a reference document, such as a document of a patient's anemia profile, are shown. The medical history display area 724 includes, if available, a link to documents that have recorded some or all of the patient's medical history.

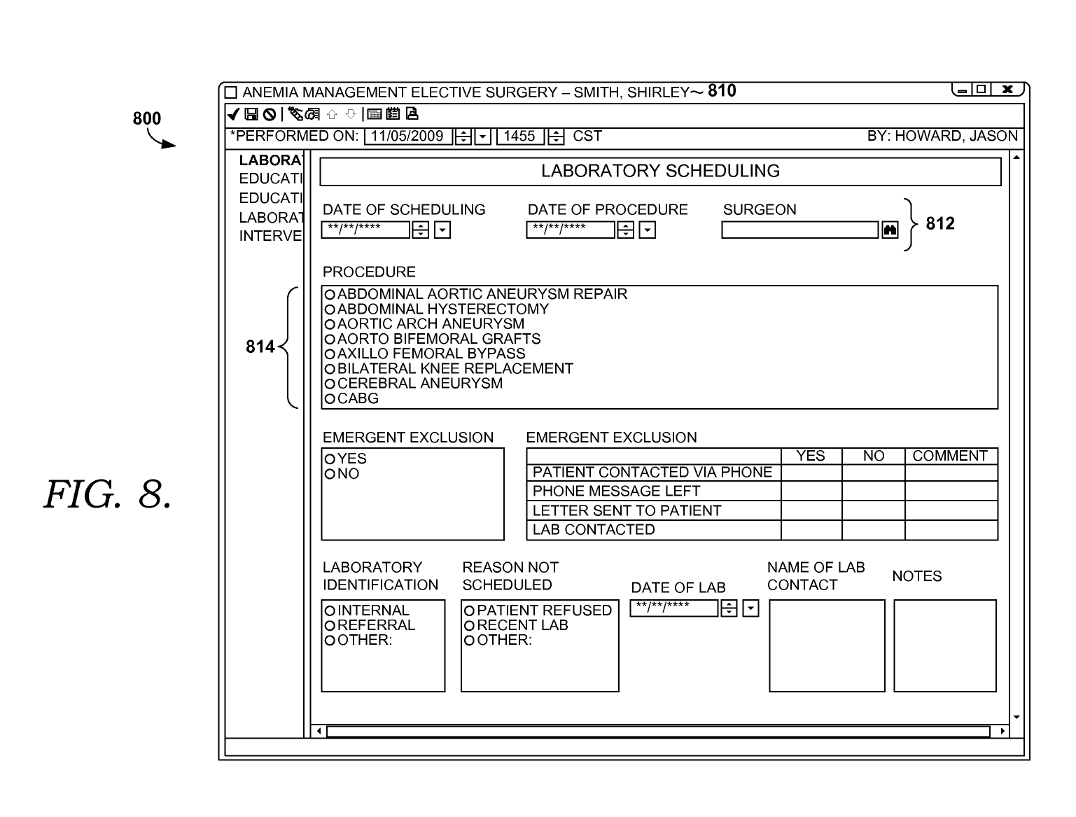

Referring now to FIG. 8, a screenshot is shown of a graphical user interface 800 for outpatient blood management, in accordance with embodiments of the present invention. The graphical user interface 800 of FIG. 8 illustrates various display areas for a specific patient. These display areas shown in FIG. 8 are generally related to the scheduling of laboratory tests, such as blood tests. This allows a clinician or other healthcare employee to schedule a laboratory test for a patient such that the information is entered and recorded into the patient's EMR. Initially, the name of the patient or other identifying information associated with the patient is shown at display area 810. At display area 812, input boxes for the date of scheduling, the date of the procedure, and the name of the surgeon are provided. A button that displays a calendar and a button that allows for a search of surgeons may be provided as well. Display area 814 allows for the clinician to select from preentered procedures, including those shown. This display area 814 may take the form of a box as is shown allowing for the clinician to select the appropriate procedure, a dropdown box listing procedures, or a user-input box wherein the clinician manually types in the name of the procedure. Other display areas including emergent exclusion, laboratory identification, reason not scheduled, the date of the lab, the name of lab contact, and a notes area are also shown.

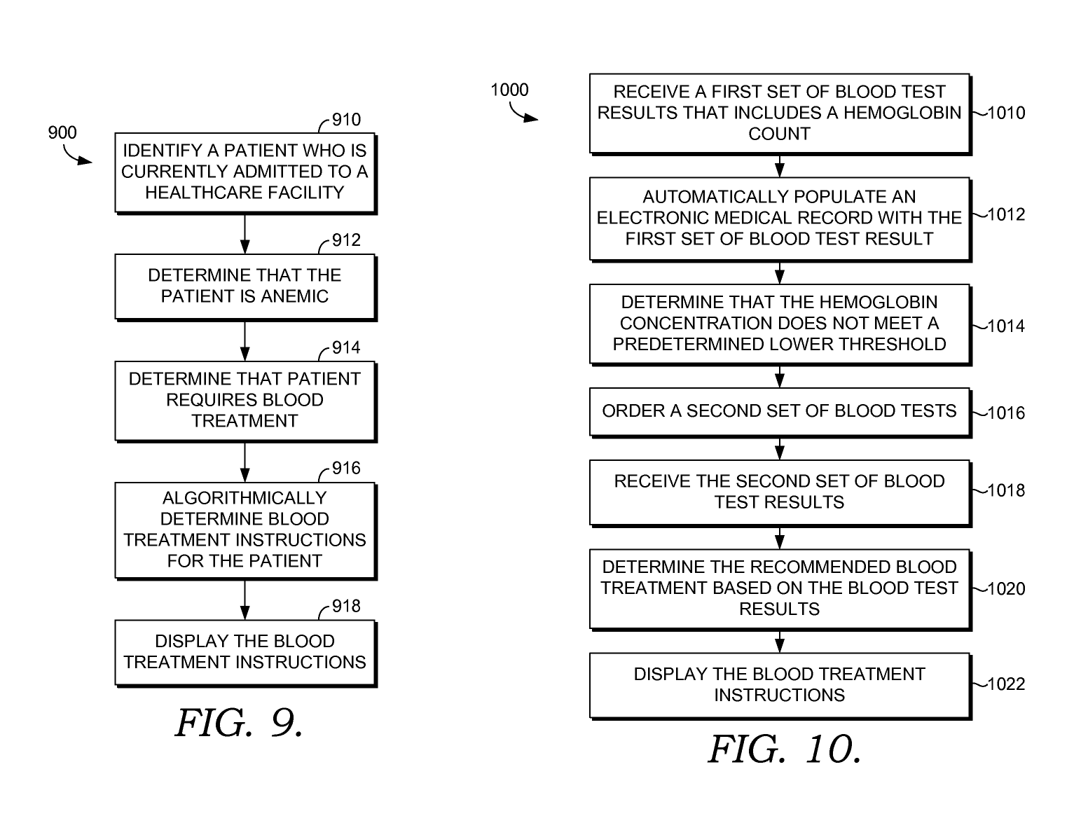

FIG. 9 is a flow diagram showing a method 900 for inpatient blood management, in accordance with an embodiment of the present invention. As mentioned above, inpatient blood management refers to the management of a patient's blood who may not have a procedure scheduled but who could benefit from some type of intervention as a result of the patient being anemic. In one embodiment, the patient does not have any procedure scheduled while admitted to the healthcare facility, but in another embodiment, the patient has a scheduled procedure that is not a procedure that is associated with a high risk of blood loss. Those patients who are identified as being anemic but who do not have a scheduled procedure or have a scheduled procedure that is not associated with a high risk of blood loss may not normally receive any blood treatment. Initially, at step 910, a patient is identified who is currently admitted to a healthcare facility. The patient may be identified, for example, based on one or more blood test results associated with the patient, such as a hemoglobin concentration, a hematocrit measurement, or a red blood cell count. In one embodiment, multiple patients' blood test results are reviewed and analyzed to select those that may benefit from blood treatment. At step 912, it is determined that the patient is anemic. Anemia may be diagnosed based on one or more red blood cell measurements that are below a predetermined threshold. For instance, a patient whose hemoglobin concentration is less than twelve g/dL may be considered anemic. This number may be different depending on a patient's gender, age, overall health, etc.

At step 914, it is determined that the patient requires blood treatment based on the red blood cell measurements. Blood treatment instructions for the patient are algorithmically determined at step 916. In embodiments, additional blood tests may be ordered to determine whether the patient is anemic or to determine the interventions that are recommended for the patient. These blood tests may include, for example, a vitamin B12 level, a reticulocyte count, reticulocyte hemoglobin content, iron binding capacity, ferritin, transferring saturation, or creatinine. Blood treatment instructions provide recommendations to the patient's caregiver or other healthcare personnel as to which interventions are to be administered to the patient. The blood treatment instructions are based on many factors, including factors such as personal information associated with the patient (e.g., gender, age), the patient's medical history, the patient's most recent blood test results, etc. Exemplary interventions include erythropoietin, intravenous or oral iron supplementation, folate, vitamin B12, vitamin C, and a nephrology consultation. These interventions may be administered in combination or individually. At step 918, the blood treatment instructions are displayed such that the clinician or other healthcare personnel can decide whether to treat the patient as recommended. The blood treatment instructions may be displayed on a page associated with the patient's EMR. The blood treatment instructions may include dosages for each recommended intervention, if applicable. For instance, the clinician may input a target hemoglobin level, and the dosages of the blood treatment interventions, such as iron, that are included in the blood treatment instructions for the patient are calculated and displayed.

Turning to FIG. 10, a flow diagram is shown of a method 1000 for inpatient blood management, in accordance with an embodiment of the present invention. Embodiments of the present invention provide that one or more patients may be identified as being potential candidates for blood treatment. The blood treatment does not include a blood transfusion, but instead includes replacement and supplementation of various vitamins, minerals, etc. At step 1010, a first set of blood test results are received, and includes a hemoglobin count. In an embodiment, the patient has been admitted to a healthcare facility and is not scheduled for a procedure that is associated with a high risk of blood loss. Oftentimes, blood tests do not need to be repeated if they were performed within a predetermined number of days. For instance, blood tests that were performed within the past 45 days may still be accurate and thus may not need to be repeated. These previously-taken test results may, in one instance, already be available in the patient's EMR.

At step 1012, an EMR associated with the patient is automatically populated with the first set of blood test results. It is determined that the hemoglobin concentration does not meet a predetermined threshold at step 1014, thus indicating that the patient is anemic. A second set of blood tests is then ordered at step 1016, which may be ordered in response to the results of the first blood test results. For instance, depending on a hemoglobin concentration, additional blood tests may be ordered that measure TSAT, Ferritin, RHC, reticulocyte count, reticulocyte hemoglobin content, iron, IBC, etc. The second set of blood tests may be ordered to determine the recommended blood treatment. At step 1018, the second set of blood test results are received. The recommended blood treatment is determined based on the blood test results from the first and the second set of blood tests, shown at step 1020. The blood treatment instructions are displayed at step 1022. After the blood treatment, the patient may be asked to have the blood tests repeated so that it can be determined whether the red blood cell measurements have improved as a result of the treatment. The goal is for the patient to no longer be anemic after completion of the blood treatment.

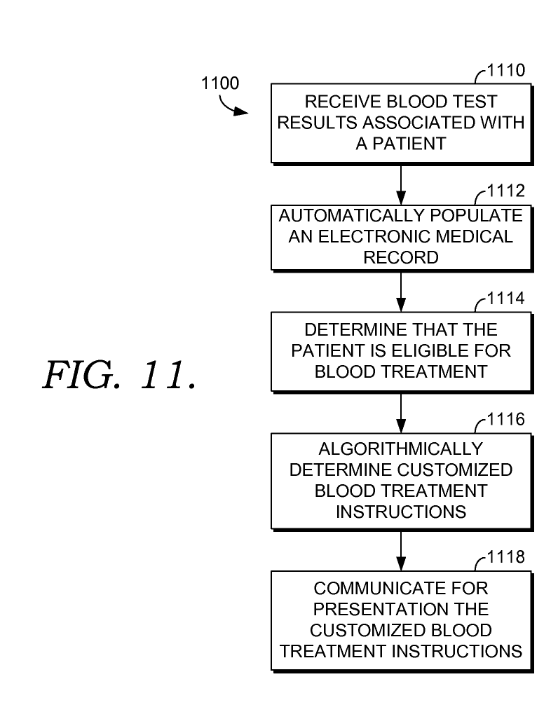

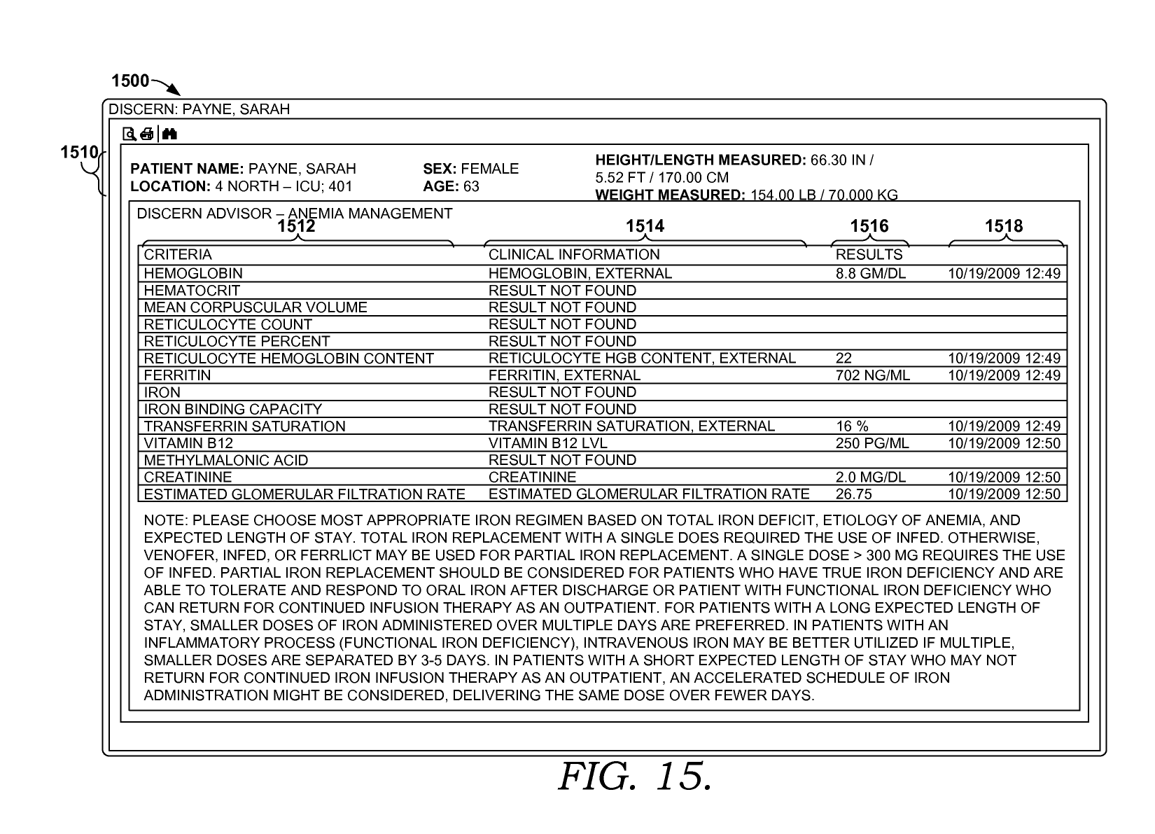

FIG. 11 is a flow diagram illustrating a method 1100 for inpatient blood management, in accordance with an embodiment of the present invention. Initially at step 1110, blood test results associated with a patient are received. The patient may have been admitted to a healthcare facility, and as such may not have a scheduled procedure that is associated with a high risk of blood loss. At step 1112, the EMR associated with the patient is automatically populated with the blood test results. An exemplary EMR having the patient's blood test results is illustrated in FIG. 15. The blood test results indicate levels of, for example, hemoglobin, hematocrit, or red blood cells. It is determined at step 1114 that the patient is eligible for blood treatment. This determination is typically made when the blood test results indicate that the patient is anemic and could benefit from blood treatment, whether or not the patient has a scheduled procedure.

At step 1116, customized blood treatment instructions are algorithmically determined based on the patient's blood test results. In addition to the blood test results received at step 1110, additional blood tests may be ordered and performed on the patient to further determine the customized blood treatment instructions. Customized blood treatment instructions may include various interventions and dosages for each intervention, as required. Dosages may be automatically calculated based on the blood test results, patient-specific information (e.g., age and gender), the patient's medical history, target red blood cell levels (e.g., hemoglobin concentration), etc. FIGS. 12-14 illustrate an exemplary method for algorithmically determining blood treatment instructions. At step 1118, the customized blood treatment instructions are communicated for presentation. The customized blood treatment instructions may be populated into the patient's EMR.

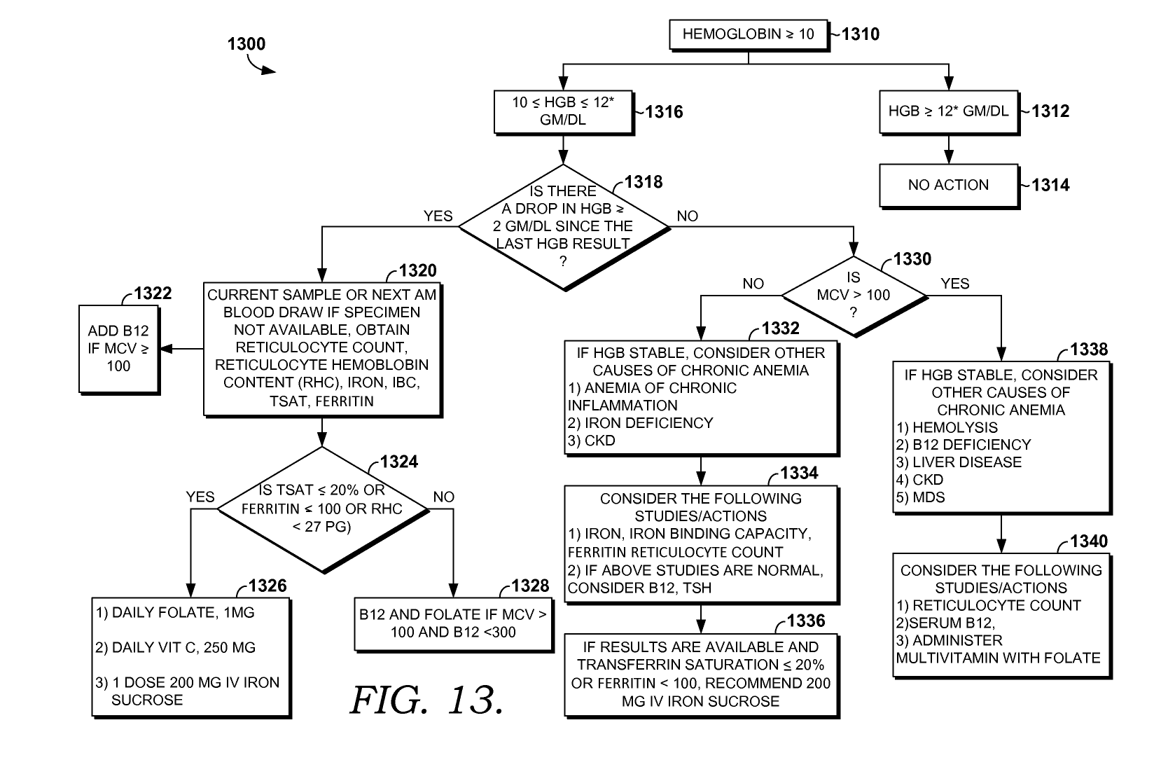

FIG. 12 is a flow diagram of a method 1200 used to determine blood treatment instructions for inpatient blood management, in accordance with an embodiment of the present invention. Initially, it is noted that FIG. 12 is merely one example of a flow chart for determining blood treatment instructions. For instance, the numbers used in the flow chart are shown for exemplary purposes only, not to limit embodiments of the present invention. For instance, while this particular embodiment begins with a hemoglobin concentration of less than ten, this number may be increased or decreased based on many factors, including patient-specific information. For example, women tend to have lower hemoglobin levels than men, and as such the threshold for a women's hemoglobin level in requiring blood treatment may be lower than a man's. Further, in the embodiments of FIGS. 12 and 13, it is first determined whether the patient's hemoglobin concentration is less than ten or greater than or equal to 10 g/dL. If the patient's hemoglobin concentration is less than 10 g/dL, FIG. 12 is used to determine blood treatment instructions.

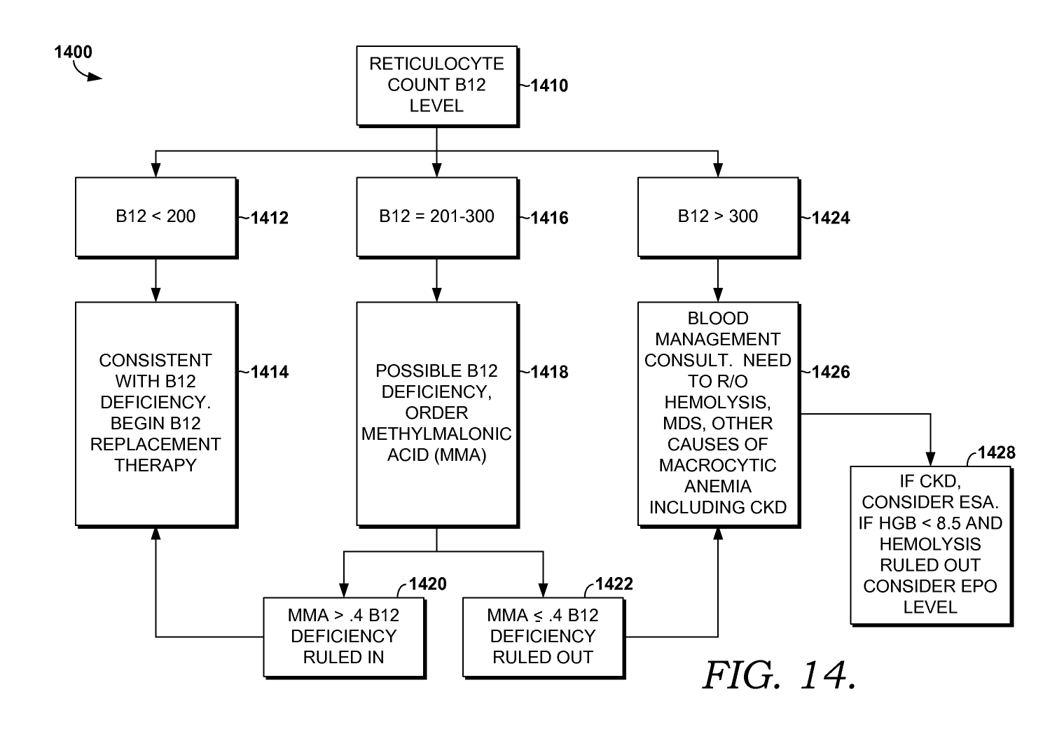

As shown at step 1210, if the patient's hemoglobin concentration is less than 10 g/dL, it is further determined whether the hemoglobin concentration is less than 8.5 g/dL, shown at step 1212. If so, one of several steps may be taken, illustrated at step 1214. The provider, such as the clinician or other hospital personnel may be alerted. The alert may take the form of a page or other message sent directly to the clinician who is associated with the patient, or may be provided on the patient's EMR. Next, creatinine clearance is analyzed, and if it is below 30 ml/min, a nephrology consult is to be considered by the clinician. Information for a nephrology expert who is recommended may be provided. Further, a blood management consult is also to be considered. A blood management consult may be performed by an expert in the field. Information for that expert may be provided. At step 1216, a current sample or the next blood sample taken is to test for a vitamin B12 level, reticulocyte count, RHC, iron, IBC, ferritin, TSAT, and creatinine. Other blood tests may also be performed. When the results are received, if vitamin B12 is less than 300, shown at step 1218, a vitamin B12 deficiency is confirmed and B12 replacement therapy may begin, illustrated at step 1220. A more detailed analysis of vitamin B12 replacement therapy is discussed herein in relation to FIG. 14. At step 1222, if the patient's ferritin is greater than 800 or the TSAT is greater than 30%, a blood management consult is recommended at step 1224. If not, step 1226 illustrates various interventions that may be recommended to the clinician, including IV iron up to 600 mg (e.g., Venofer) and daily folate supplementation. The clinician is reminded to consider the patient's EPO level if the creatinine clearance is less than 60 mL/min.

If, however, the patient's hemoglobin concentration is between 8.5 and 10, including 8.5 at step 1228, the provider or clinician may be alerted at step 1230, and a nephrology consult is recommended if the patient's creatinine clearance is less than 30 mL/min. At step 1232, a current sample or the next blood sample taken is to test for a vitamin B12 level, reticulocyte count, RHC, iron, IBC, ferritin, TSAT, and creatinine. Other blood tests may also be performed. At step 1233, if MCV is greater than or equal to 90, B12 therapy is considered. At step 1234, if B12 is less than 300 at step 1234, step 1236 indicates that B12 deficiency is confirmed and B12 replacement therapy may begin. Vitamin B12 replacement therapy is discussed in greater detail herein in relation to FIG. 14. At step 1238, it is determined whether the patient's ferritin level is less than 800 and the TSAT is less than 20%, or whether the TSAT is less than 30% with decreased retic hemoglobin content (RHC) (e.g., if RHC is less than 27 pg). If either of these is true, step 1240 indicates that IV iron is to be used for blood treatment for the patient. The iron may be given as Venofer in divided doses, and the remaining dose is to be administered as iron Dextran or iron sucrose after the patient has been discharged. If neither is true at step 1238, step 1242 indicates three separate considerations. First, causes of anemia other than functional iron deficiency are to be considered. Second, lab testing for vitamin B12, folate, and EPO level are to be considered. Third, if the patient's hemoglobin concentration is decreasing, a blood management consultation is to be considered.

Referring now to FIG. 13, a flow diagram is shown of a method 1300 that is used to determine blood treatment instructions for inpatient blood management, in accordance with an embodiment of the present invention. If it is initially determined that the patient's hemoglobin concentration is greater than or equal to 10 g/dL, as shown at step 1310, it is then determined whether the patient's hemoglobin concentration is greater than or equal to 10 g/dL and less than 12 g/dL, or greater than or equal to 12 g/dL. If it is determined the patient's hemoglobin concentration is greater than or equal to 12 g/dL at step 1312, no action is needed, shown at step 1314. If, however, it is determined that the patient's hemoglobin concentration is equal to 10 g/dL and less than 12 g/dL at step 1316, it is determined at step 1318 whether there is a 2 g/dL or greater drop in the patient's hemoglobin concentration since the last blood test that tested for hemoglobin. If the drop is 2 g/dL or greater, step 1320 indicates that a current sample or the next blood sample taken is to test for a reticulocyte count, RHC, iron, IBC, ferritin, and TSAT. Other blood tests may also be performed. Further, if MCV is greater than or equal to 100, B12 replacement therapy is recommended, as shown at step 1322. It is determined at step 1324 whether TSAT is less than or equal to 20%, whether ferritin is less than or equal to 100, or whether RHC is less than 27 pg. If any of these are true, the recommended interventions include, as shown at step 1326, daily folate (e.g., 1 mg), daily vitamin C (e.g., 250 mg), and one dose of IV iron sucrose (e.g., 200 mg). At step 1328, if none are true at step 1324, vitamin B12 replacement therapy and folate supplementation are recommended if MCV is greater than 100 and if B12 is less than 300.

Returning now to step 1318, if there is not a 2 g/dL or greater drop in the patient's hemoglobin concentration, it is determined at step 1330 whether MC is greater than 100. If it is not, step 1332 indicates that if the patient's hemoglobin concentration is stable other causes of chronic anemia should be considered, such as anemia of chronic inflammation, iron deficiency, or chronic kidney disease (CKD). At step 1334, an indication is provided that various studies and actions should be considered, such as iron, IBC, ferritin, and reticulocyte count. If those studies are normal, vitamin B12 replacement therapy and TSH should be considered. If the results are available and the transferring saturation is less than 20% or ferritin is less than 100, it is recommended at step 1336 to treat the patient with 200 mg of IV iron sucrose. Returning to step 1330, if the patient's MCV is greater than 100, step 1338 indicates that if the patient's hemoglobin concentration is stable, other causes of chronic anemia should be considered, including hemolysis, a vitamin B12 deficiency, liver disease, CKD, and myelodysplastic syndrome (MDS). Step 1340 indicates that various studies and actions should be considered, including the reticulocyte count, serum B12, and recommends the administration of a multivitamin with folate. While the algorithms described in relation to FIGS. 13 and 14 can be used to automatically provide a clinician with blood treatment instructions, it is ultimately the clinician's responsibility to review the provided blood treatment instructions and determine, based on the clinician's knowledge of the patient's medical history, which of the interventions the patient will receive.

Turning to FIG. 14, a flow diagram of a method 1400 used to determine blood treatment instructions for inpatient blood management is shown, in accordance with an embodiment of the present invention. As mentioned in relation to FIG. 12, FIG. 14 provides recommendations as to vitamin B12 replacement therapy. Step 1410 indicates that the reticulocyte count and B12 levels are considered. If the B12 level is less than 200 at step 1412, step 1414 indicates that there is likely a B12 deficiency, and that B12 replacement therapy should begin. If, at step 1416, B12 is 201-300, step 1418 indicates that there is a possible B12 deficiency, and that a methylmalonic acid (MMA) test should be ordered. When returned, if MMA is greater than 0.4 at step 1420, B12 deficiency is likely, and B12 replacement therapy should begin. If MMA is less than or equal to 0.4, B12 deficiency is ruled out at step 1422 and a blood management consultation is needed to rule out other causes of a low hemoglobin concentration, such as hemolysis, MDS, and other causes of macrocytic anemia including CKD. This is shown at step 1426. Similarly, if B12 is greater than 300 at step 1424, the same recommendations are provided at step 1426, including a blood management consultation to rule out other causes of a low hemoglobin concentration, such as hemolysis, MDS, and other causes of macrocytic anemia including CKD. At step 1428, if the patient is determined to have CKS, ESA is to be considered. Further, if the patient's hemoglobin concentration is less than 8.5 and hemolysis is ruled out, the EPO level should be considered.

FIG. 15 is a screenshot of a graphical user interface 1500 for inpatient blood management, in accordance with embodiments of the present invention. A patient-identifying display area 1510 includes information associated with the patient including, for instance, the patient's name, location in the healthcare facility, gender, age, height, and weight. The blood test display area 1512 lists criteria or various blood tests that have or are scheduled to be performed on the patient. The clinical information display area 1514 displays more detailed information about the criteria listed in the blood test display area 1512. The results display area 1516 displays the blood test results, if they have been received. Finally, the date and time display area 1518 displays the date and time that each blood test was performed. It should be noted that other display areas are contemplated to be within the scope of the present invention even though they are not shown in the embodiment of FIG. 15.

Referring to FIG. 16, a screenshot is illustrated of a graphical user interface 1600 for inpatient blood management, in accordance with embodiments of the present invention. A patient-identifying display area 1610 lists the patient's name, location, gender, age, height, and weight. This area may list other patient information and may even have a link to a separate page that includes more detailed patient information. Blood treatment display areas 1612 and 1616 display the recommended blood treatment for a particular patient. In one embodiment, these display areas also allow a clinician to order a particular intervention for a patient by checking a box. For instance, folic acid administered at 1 mg daily is selected for the patient identified as Sarah Payne. A nephrology consult is also selected. These may be automatically selected, or may be manually selected by a clinician. Dosage calculation display area 1614 allows a clinician to enter a target hemoglobin concentration value so that various dosages can be accurately calculated. For instance, an InFed dosage of 1200 mg has been calculated. Instructions on how to administer may also be provided.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform a method comprising:
identifying a patient who is currently admitted to a healthcare facility;
determining that the patient is anemic such that one or more red blood cell measurements associated with the patient are below a predetermined threshold;
determining that the patient requires blood treatment based on the one or more red blood cell measurements;
algorithmically determining blood treatment instructions for the patient; and
displaying the blood treatment instructions.

2. The one or more computer storage media of claim 1, wherein the patient is not currently scheduled for a procedure that is associated with a high risk of blood loss.

3. The one or more computer storage media of claim 1, wherein the one or more red blood cell measurements includes a hemoglobin concentration.

4. The one or more computer storage media of claim 1, wherein the one or more red blood cell measurements comprises one or more of a hematocrit measurement or a red blood cell count.

5. The one or more computer storage media of claim 1, wherein the blood treatment instructions include one or more of erythropoietin, intravenous or oral iron, folate, vitamin B12, vitamin C, or a nephrology consultation.

6. The one or more computer storage media of claim 1, further comprising tracking blood test results for a plurality of patients to identify those that are eligible for the blood treatment.

7. The one or more computer storage media of claim 6, wherein one of the plurality of patients is eligible for the blood treatment if the blood test results indicate anemia.

8. The one or more computer storage media of claim 1, wherein the blood treatment does not include a blood transfusion.

9. The one or more computer storage media of claim 1, further comprising ordering blood tests other than the red blood cell measurements to determine that the patient is anemic, wherein the blood tests include a vitamin B12 level, a reticulocyte count, reticulocyte hemoglobin content, iron binding capacity, ferritin, transferring saturation, or creatinine.

10. The one or more computer storage media of claim 3, wherein algorithmically determining the blood treatment instructions for the patient further comprises:
receiving an input of a target hemoglobin level; and
calculating a dosage of one or more blood treatment interventions that are included in the blood treatment instructions for the patient based on a current hemoglobin level and the target hemoglobin level.

11. One or more computer storage media storing computer-useable instructions that, when used by one or more computing devices, cause the one or more computing devices to perform a method comprising:
receiving a first set of blood test results that includes a hemoglobin count for a patient who has been admitted to a healthcare facility, wherein the patient is not scheduled for a procedure that is associated with a high risk of blood loss;
automatically populating an electronic medical record associated with the patient with the first set of blood test results;
determining that the hemoglobin count does not meet a predetermined lower threshold indicating that the patient is anemic;
ordering a second set of blood tests to determine a recommended blood treatment;
receiving a second set of blood test results;
determining the recommended blood treatment based on the first set of blood test results and the second set of blood test results; and
communicating for display on the electronic medical record blood treatment instructions.

12. The one or more computer storage media of claim 11, wherein the first set of blood test results are associated with a first set of blood tests that were previously performed within a predetermined quantity of days such that the first set of blood tests is still accurate.

13. The one or more computer storage media of claim 12, wherein the predetermined quantity of days is 45.

14. The one or more computer storage media of claim 11, further comprising identifying a plurality of patients from a database who meet criteria for receiving the blood treatment, wherein the blood treatment does not include a blood transfusion.

15. The one or more computer storage media of claim 11, further comprising:
upon completion of the blood treatment, receiving one or more post-treatment blood test results for the patient; and
based on the one or more post-treatment test results, determining that the patient is no longer anemic.

16. The one or more computer storage media of claim 11, wherein the blood treatment is performed to avoid a blood transfusion.

17. One or more computer storage media storing computer-useable instructions that, when used by one or more computing devices, cause the one or more computing devices to perform a method comprising:
receiving blood test results associated with a patient who has been admitted to a healthcare facility;
automatically populating an electronic medical record associated with the patient with the blood test results, wherein the blood tests results indicate levels of one or more of a hemoglobin concentration, hematocrit, or a red blood cell count;
based on the blood test results, determining that the patient is eligible for blood treatment such that the blood test results indicate that the patient is anemic;
algorithmically determining customized blood treatment instructions that are based on the blood test results for the patient; and
communicating for presentation the customized blood treatment instructions.

18. The one or more computer storage media of claim 17, wherein the customized blood treatment instructions include one or more blood treatment interventions and dosages for each of the one or more blood treatment interventions.

19. The one or more computer storage media of claim 17, further comprising ordering additional blood tests to determine the customized blood treatment instructions.

20. The one or more computer storage media of claim 17, wherein the patient is not currently scheduled to undergo a procedure that is associated with a high risk of blood loss.
